(19) United States
(12) Patent Application Publication
(10) Pub. No.: US 2008/0088551 A1
(43) Pub. Date: Apr. 17, 2008

(54) Microfluidic prism

(75) Inventor: Andrei Cernasov, Ringwood, NJ (US)

Correspondence Address: HONEYWELL INTERNATIONAL INC.;Law Department AB 2, P.O. Box 2245, Morristown, NJ, 07962-9806, US

(73) Assignee: HONEYWELL INTERNATIONAL INC.

(21) Appl. No.: 11/546,441

(22) Filed: Oct. 12, 2006

(51) Int. Cl. G09G 3/34

(52) U.S. Cl. 345/84

(57) ABSTRACT

A projection-type imaging array comprising a plurality of microfluidic devices are provided, each microfluidic device having a reservoir containing first and second fluids that are immiscible with respect to teach other. A drive unit is provided for each microfluidic device to selectively displace the surface formed at the interface between the first and second fluids. Accordingly, when a particular microfluidic device is turned OFF according to the drive unit, the interface surface is positioned to redirect incoming light (via reflection/refraction) toward an absorptive surface. Conversely, when the microfluidic device is turned ON, the interface surface is positioned so that the incoming light is directed toward the display surface.

### CROSS-REFERENCES TO RELATED APPLICATIONS

The present application is related to co-pending U.S. patent application Ser. No. ______, entitled “Microfluidic Imaging Array,” which was filed on _, the entire contents of which are hereby incorporated by reference in their entirety.

### FIELD OF THE INVENTION

The present invention relates to a microfluidic device, and more particularly, to a microfluidic device incorporating a surface for selectively redirecting incoming light.

### BACKGROUND OF THE INVENTION

Among technologies in use today for projection display is the micro-mechanical device approach. An example of this is the Digital Micromirror Device™ (DMD) from Texas Instruments, which comprises an array of microscopically sized mirrors. Each mirror, which corresponds to a single pixel in the displayed image, can take one of two tilt positions: ON and OFF. In the ON position, the micro-mirror reflects incoming light through a projection lens to the screen. In the OFF position, the micro-mirror directs light away from the lens, toward a light absorber.

To display a monochrome image, the DMD controller keeps each micro-mirror in the ON position for a period of time in the frame cycle that is proportional to the desired pixel brightness. To add color, a spinning color wheel is used in connection with the DMD array projector.

For example, during each frame, white light is focused down onto a spinning color wheel filter system, causing the DMD array to be illuminated sequentially with red, green, and blue light. At the same time, an RGB video signal for each pixel is sent to the corresponding micro-mirror. As they are illuminated with each color, the mirrors are turned ON depending on how much of that color is needed. The viewer's eyes integrate these sequential images such that a full image is seen.

The DMD technology has several disadvantages. For example, it is an expensive technology and difficult to scale up and down. A DMD system cannot be upgraded to a larger size and/or higher resolution without a very large investment.

### SUMMARY OF THE INVENTION

Exemplary embodiments of the present invention provide a microfluidic device capable of selectively redirecting incoming light. Each microfluidic device includes a reservoir containing first and second fluids that are immiscible (incapable of mixing) with respect to teach other. Furthermore, an object is disposed at the interface between the first and second fluids to substantially inhibit curvature of the interface.

According to an exemplary embodiment, a flat object is disposed in a floatative state at the interface between the fluids, thereby providing a flat surface at the interface. The flattened interface surface is operable to selectively reflect or refract light transmitted to the microfluidic device. Accordingly, the microfluidic device may be designed to reflect/refract incoming light in the same manner as the micro-mechanical mirror devices utilized in existing projection display devices.

Further, the two fluids have different electrical or magnetic properties, such that the interface surface may be put into different positions (ON and OFF) through an electric or magnetic force. For instance, in the ON position, the interface surface of a microfluidic device deflects the incoming light toward a display surface. Conversely, while in the OFF position, the interface surface deflects the light away from the display surface.

The first and second fluids may have different refraction indices to ensure the reflective/refractive properties of the microfluidic device. To help ensure the incoming light is properly redirected, the floater object may be relatively thin and made of an optically clear material or a material with the same refraction index of one of the fluids. Specifically, the configuration of each microfluidic device and the refraction indices should ensure that the incoming light is redirected from the interface surface to the proper location based on the ON/OFF position of the device. However, in an alternative embodiment, one of fluids may be reflective while the other fluid and floater object are optically clear, thereby causing the microfluidic device to properly direct the incoming light based on the ON/OFF state.

Further aspects in the scope of applicability of the present invention will become apparent from the detailed description provided below. However, it should be understood that the detailed description and specific embodiments provided therein, while disclosing exemplary embodiments of the invention, are provided specifically for illustration only.

### BRIEF DESCRIPTION OF THE DRAWINGS

A more complete understanding of the present invention will become apparent from the following description taken in conjunction with the accompanying drawings, wherein:

FIGS. 1A and 1B illustrate alternative configurations for a microfluidic device, according to exemplary embodiments of the present invention;

FIGS. 2A-2C illustrate the use of electrokinetic force applied to a fluid to control the positioning of the flattened interface surface according to an exemplary embodiment, respectively, of the present invention;

FIGS. 3A-3C illustrates an exemplary embodiment of the present invention where the microfluidic device employs dielectrophoresis;

FIGS. 4A-4C and FIGS. 5A-5C illustrate the use of electrical force applied to an electrically charged interface object to control the positioning of the flattened interface surface according to alternative exemplary embodiments, respectively of the present invention;

FIGS. 6A and 6B illustrate the operation of the microfluidic device as a reflector in a projection-type display system, according to an exemplary embodiment of the present invention;

FIGS. 7A and 7B illustrate the operation of a microfluidic device as a refractor in a projection-type display system, according to an exemplary embodiment of the present invention;

FIG. 8 illustrates a drive unit configured for two-dimensional tilting of the flattened interface surface in a microfluidic device, according to an exemplary embodiment of the present invention;

FIGS. 9A-9E illustrate different positions, respectively, of the flattened interface surface in a microfluidic device capable of two-dimensional tilting, in accordance with the applied electrokinetic force, according to an exemplary embodiment of the present invention;

FIG. 10 illustrates a microfluidic device utilizing total internal reflection, according to an exemplary embodiment of the present invention;

FIG. 11 illustrates a plurality of microfluidic devices arranged as an imaging array driven by a thin-film transistor (TFT) circuit, according to an exemplary embodiment of the present invention;

FIGS. 12A-12C illustrate exemplary embodiments of the present invention where the microfluidic device employs electrowetting;

FIGS. 13A-13C and FIGS. 14A-14C illustrate the use of electrical force applied to a conductive interface object to control the positioning of the flattened interface surface according to alternative exemplary embodiments, respectively of the present invention; and

FIGS. 15A-15C and FIGS. 16A-16C illustrate the use of electrical force applied to a strongly dielectric interface object to control the positioning of the flattened interface surface according to alternative exemplary embodiments, respectively of the present invention.

### DETAILED DESCRIPTION OF EXEMPLARY EMBODIMENTS

In the present invention, the micro-mechanical device approach to projection display is replaced with the use of microfluidic devices. Specifically, each microfluidic device includes a reservoir containing two fluids that are immiscible (incapable of mixing together). The interface between these two fluids is capable of reflecting or refracting the projection light toward or away from a display surface (screen) depending on the ON/OFF state of the device. Since the fluids have different electric properties, the ON and OFF position of the interface surface may be controlled by an electrical action. To increase the precision at which the light is deflected, a flat floater object is disposed between the two fluids to help prevent, or substantially inhibit, curvature of this interface surface.

According to an exemplary embodiment, the microfluidic device may be implemented in projection-type image display system. For instance, each microfluidic device may correspond to a particular pixel element of the image. According to such an embodiment, an array of microfluidic devices may be implemented for the plurality of pixel elements within the displayed image. The system for electronically driving this microfluidic imaging array may be compatible with the thin-film transistor (TFT) that had previously been used for the manufacture of liquid crystal display (LCD) panels.

Exemplary embodiments of the present invention will be described below in connection with the accompanying figures. These figures are provided for purposes of illustration only and are not drawn to scale. Also, in the figures, like elements are denoted by like reference numbers.

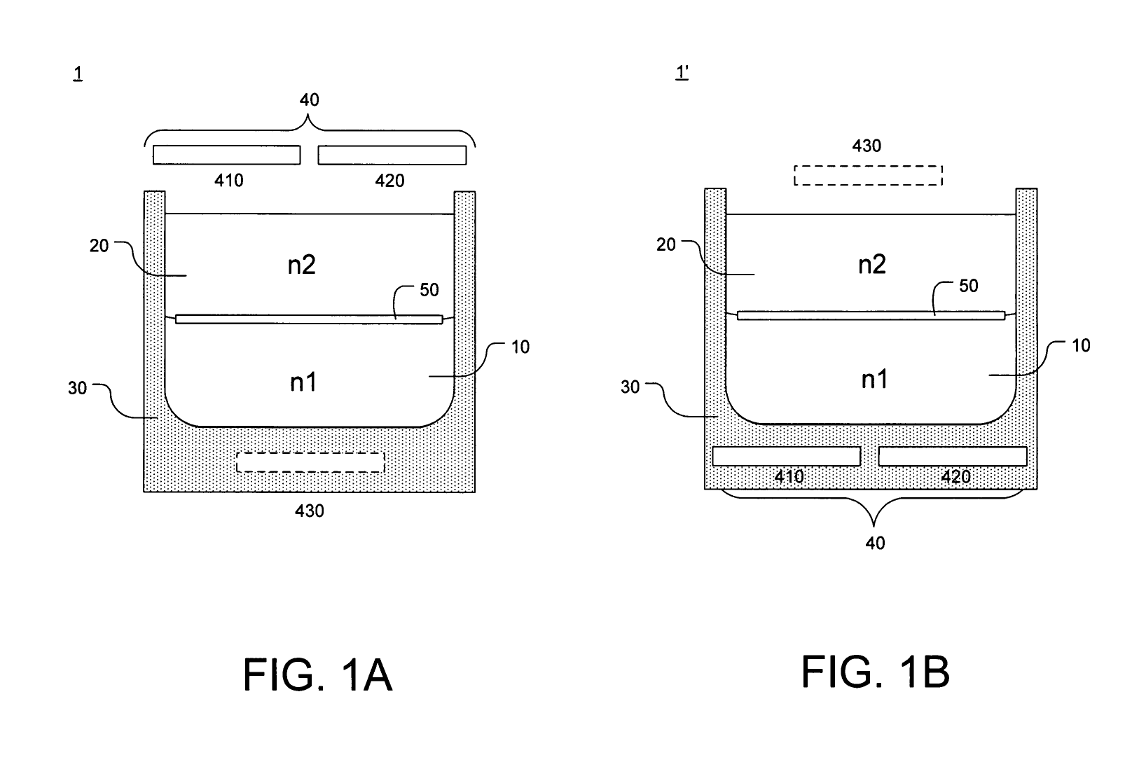

FIGS. 1A and 1B each illustrates a configuration of the microfluidic device according to an exemplary embodiment. Specifically, FIG. 1 illustrates an embodiment in which the microfluidic device 1 includes a drive unit 40 disposed above the reservoir 30 containing the first and second fluids 10 and 20, respectively, and floater object 50. FIG. 1B, on the other hand, illustrates an alternative embodiment in which the microfluidic device 1′ incorporates the drive unit 40 below the reservoir 30 containing the first and second fluids 10 and 20, respectively, and floater object 50. For example, in FIG. 1B, the drive unit 40 may be incorporated in the material of the bottom part of the reservoir.

In the microfluidic device 1, 1′ illustrated in FIGS. 1A and 1B, the first fluid 10 and second fluid 20 are immiscible and, thus, do not mix with each other. As such, a distinct surface is formed within the reservoir 30 at the interface of the first and second fluids 10 and 20. Furthermore, the first and second fluids 10 and 20 may be electrically or magnetically different. This allows the steering electrodes 410 and 420 of the drive unit 40 to displace the interface surface between the first and second fluids 10 and 20 through the selective application of voltage to each electrode 410, 420. The microfluidic device 1, 1′ may include an additional electrode 430. For instance, in order to satisfy electric balancing conditions the additional electrode 430 may be grounded or set to a particular potential. However, the inclusion of this third electrode 430 is optional, as indicated by the dotted lines, because it may not be needed in embodiments utilizing an electrically conductive fluid 10, which may be separately grounded or set to a particular potential.

According to an exemplary embodiment, the floater object 50 is a flat piece of material, which is optically transparent or has the same refraction index of one of the fluids 10 and 20. However, in an alternative embodiment, the floater object 50 may itself exhibit optical characteristics for reflecting or refracting the light. For example, according to this alternative embodiment, the fluids 10 and 20 may be optically clear, and the optical characteristics of the floater object 50 may be responsible for reflecting or refracting the light to an appropriate location.

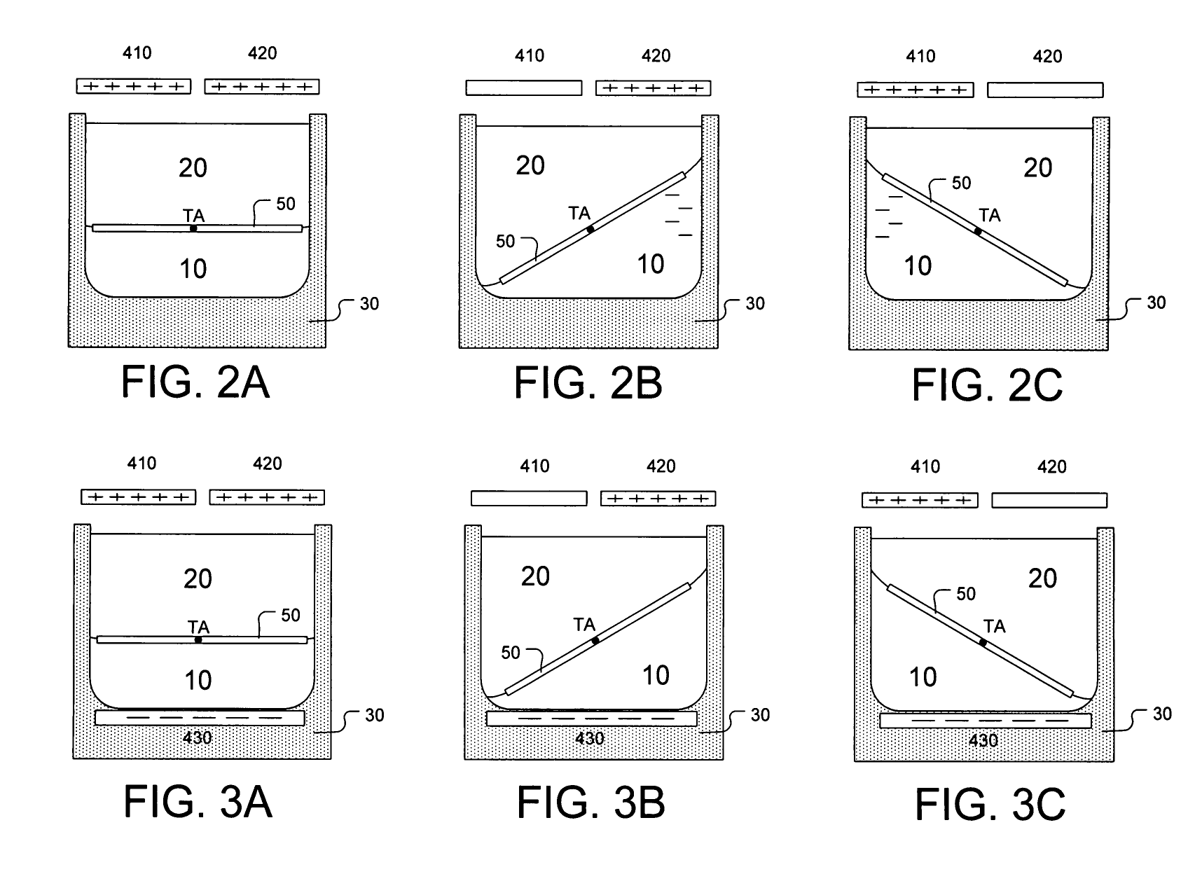

As shown in FIGS. 1A and 1B, the floater object 50 should also be relatively thin. Furthermore, there should be some clearance between the floater object 50 and the walls of the reservoir 30 to allow the floater object 50 to seamlessly change positions in correlation with the interface surface (as controlled by the drive unit 40). The operative principles of the drive unit 40 will be described in more detail below in connection with FIGS. 2A-2C and FIGS. 3A-3C.

The shape of the floater object 50 may be varied, e.g., according to design parameters. The floater object 50 may have a circular or rounded face, particularly in instances where the reservoir 30 has a cylindrical shape. As such, the floater object may be configured as a disc-like object. Many other shapes are possible for the floater object 50, as will be contemplated by those of ordinary skill in the art. However, as discussed above, the dimensions of the floater object 50 should allow for some clearance between the floater object 50 and the reservoir walls to ensure that the floater object 50 remains in a floatative state as the interface surface changes positions.

As mentioned above, since fluids 10 and 20 are immiscible, a distinct interface surface would be formed between them even if the floater object 50 were not included. However, without the floater object 50, the curvature of the interface between these fluids 10 and 20 would likely produce unwanted angular dispersion between the rays of light to be reflected or refracted by the interface surface. Accordingly, the purpose of the floater object 50 is to “flatten out” the interface surface and remove such angular dispersion. As such, the term “flattened interface surface,” as used hereinafter, refers to the disposition of the floater object 50 at the interface between fluids 10 and 20.

Referring again to FIGS. 1A and 1B, in an exemplary embodiment, one of the fluids 10 and 20 has a higher level of electrical conductivity than the other. Thus, when a voltage is applied to only one of the steering electrodes 410 and 420, the resultant non-uniform electric filed applied by the drive unit 40 causes the fluid of higher electrical conductivity to be displaced toward one of the electrodes 410 and 420. This movement is caused by electrophoresis. The movement of the higher-conductivity fluid 10 or 20 causes the interface surface to change position, as will be described in more detail below in connection with FIGS. 2A-2C.

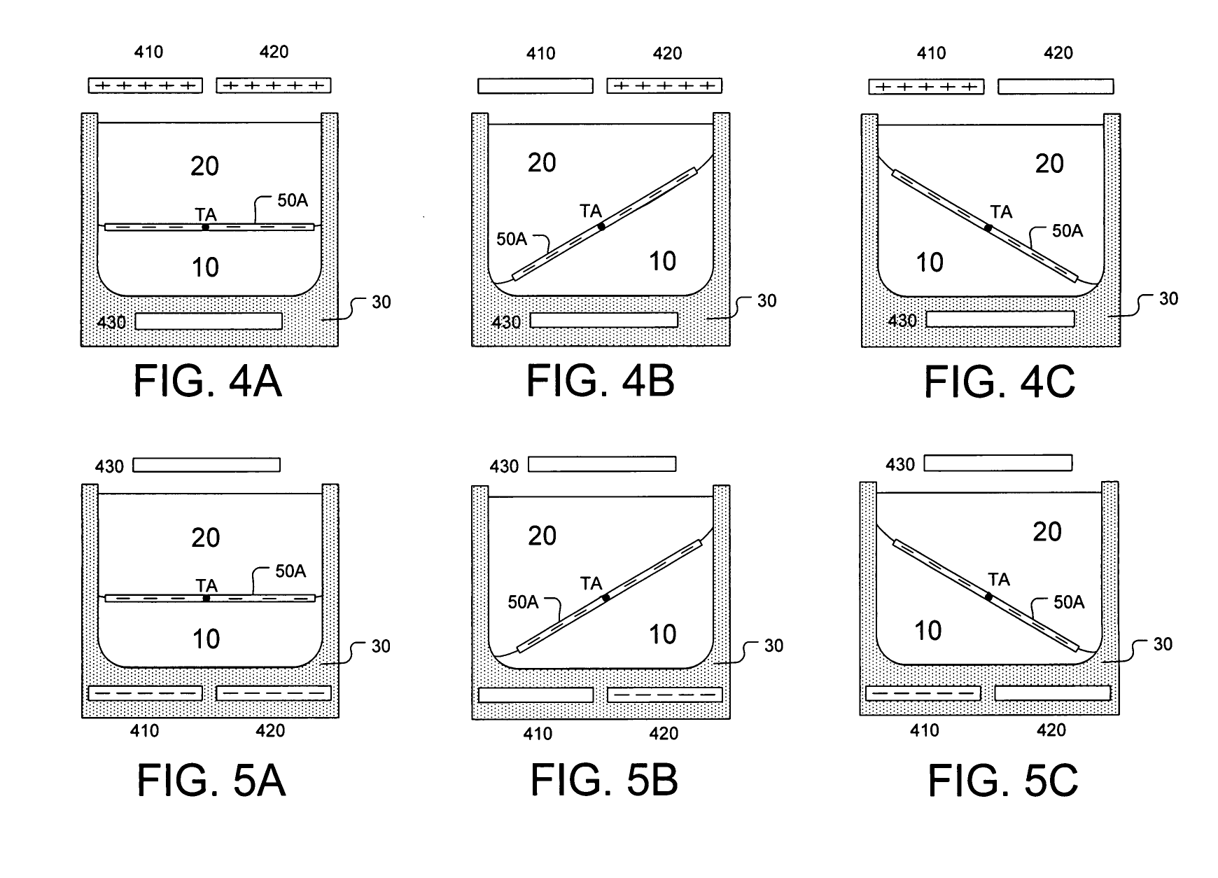

However, according to an alternative exemplary embodiment, the floater object 50 itself may be electrically charged, or made of a conductive or strongly dielectric material. In any of these embodiments, the selective application of voltage to steering electrodes 410 and 420 may cause electrical or magnetic forces to be applied directly to the floater object 50, thereby causing both the floater object 50 and the interface surface to change positions. Such embodiments are described in more detail below in connection with FIGS. 4A-4C, FIGS. 5A-5C, and FIG. 13A et seq.

However, in an alternative example embodiment, another type of electrokinetic force may be applied to cause the interface surface (and floater object 50) to change positions.

For example, a dielectrophoretic force may be applied to cause the flattened interface surface to change positions. In this embodiment, the first and second fluids 10 and 20 have different dielectric coefficients (i.e., electric permittivities). Thus, the application of a non-uniform electric field across the interface surface through the operation of steering electrodes 410 and 410 causes the fluid 10 and 20 of higher permittivity to move toward a selected one of the electrodes. This embodiment may work with a set of steering electrodes 410, 420, and 430 illustrated in FIGS. 3A-3C.

First, the exemplary embodiment utilizing electrophoresis to switch the microfluidic device 1, 1′ between its ON and OFF will be described. As such, it will be assumed that one of the first and second fluid 10 and 20 has a higher level of electrical conductivity than the other. This fluid will sometimes be referred hereinafter as the “electrically conductive fluid,” even though the other fluid may also be electrically conductive (at a lower magnitude). However, it would readily apparent to those of ordinary skill in the art that many of the principles described with respect to this embodiment are also applicable to alternative embodiments utilizing dielectrophoresis and fluids of different dielectric coefficients.

In an exemplary embodiment, the electrically conductive fluid may be chosen from water, aromatic fluids like benzene, or some electrically conducting aqueous solution. The other fluid (sometimes referred to herein after as “insulating fluid”) could be, for example, silicon oil or vegetable oil. However, the choice of fluids 10 and 20 are not necessarily limited to liquids. For instance, assuming that the second fluid 20 is designed as the insulating fluid, it may comprise a gas (although precautions may need to be taken to prevent the electrically conductive fluid 10 from evaporating).

Referring to FIGS. 1A and 1B, the drive unit 40 may be installed above or below the reservoir 30 according to alternative embodiments. In FIG. 1A, the microfluidic device 1 is configured with the drive unit 40 above the reservoir. For example, the drive unit 40 may be part of the structure that seals the first and second fluids 10 and 20 into the reservoir 30. Alternatively, FIG. 1B illustrates an embodiment of the microfluidic device 1′ in which the drive unit 40 is installed below the first and second fluids 10 and 20. In the particular case shown in FIG. 1B, the steering electrodes 410 and 420 may be incorporated into the bottom wall of the reservoir 30.

FIGS. 2A-2C illustrate the operation of the steering electrodes 410 and 420 in selectively displacing the interface surface and floater object 50 into different operative positions, according to the embodiment of the microfluidic device 1 illustrated in FIG. 1A.

The embodiment illustrated in FIGS. 2A-2C show examples of using electrophoresis to cause the interface surface to shift between different positions. In these embodiments, the first fluid 10 is assumed to be the electrically conductive fluid, while the second fluid 20 is the insulating fluid. However, such embodiments are not to be limiting. As discussed above, another type of electrokinetic force (e.g., dielectrophoresis) may be used. Also, the choice of electrically conductive and insulating fluids may be reversed.

According to an exemplary embodiment, the ON/OFF state of the microfluidic device 1, 1′ may correspond to different tilt angles of the interface circuits. With the use of two steering electrodes 410 and 420, it is possible to displace interface surface into a multitude of different states or tilt angles.

Referring to FIGS. 2A-2C, the selected application of positive voltage to one or both of the steering electrodes 410 and 420 causes the interface surface to take on a particular tilt angle with respect to the tilt axis TA. In FIG. 2A, the application of a positive voltage to both steering electrodes 410 and 420 causes a uniform electric field above the fluids 10 and 20, such that the interface surface has relatively little or no tilt with respect to the tilt axis TA. However, in FIG. 2B, the application of a positive voltage only to steering electrode 420 attracts the electrically conductive fluid 10 to that electrode, thereby causing the interface surface to tilt toward steering electrode 420. In FIG. 2C, the application of the positive voltage only to steering electrode 410 has the reverse effect, thereby attracting the electrically conductive fluid 10 so that the interface surface tilts toward steering electrode 410.

In FIGS. 2B and 2C, the amount of tilt is a function of the amount of voltage applied to the respective steering electrode 410, 420 and other design parameters such as the choice of fluids 10 and 20.

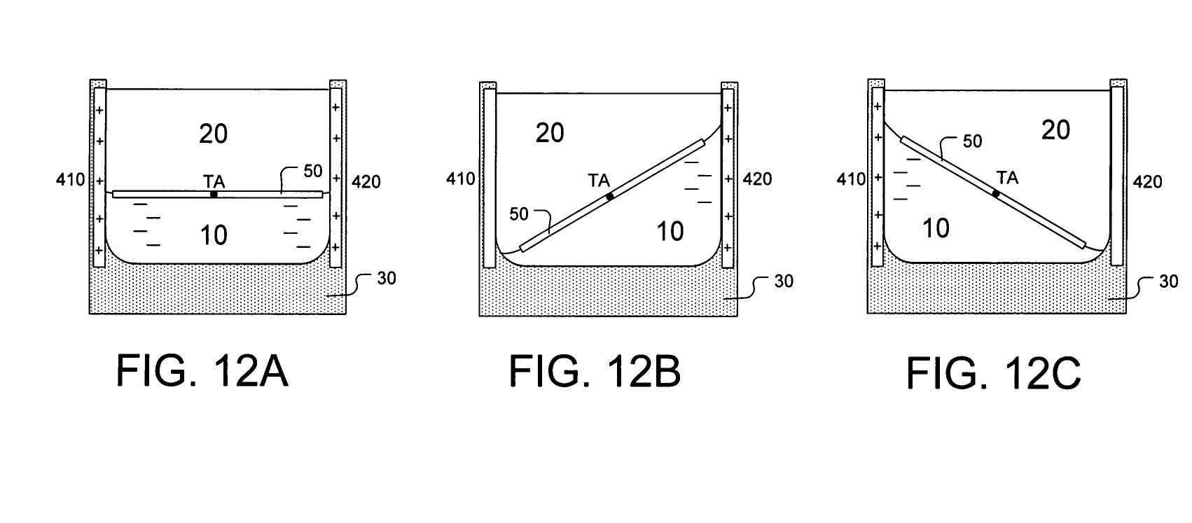

Although FIGS. 2A-2C illustrate a particular embodiment of the invention, it should be noted that these figures are merely illustrative, and other configurations are possible. For instance, the drive unit 40 may comprise steering electrodes disposed at opposing sides of the reservoir 30. For instance, if such steering electrodes are implemented within the side walls of the reservoir 30, electrowetting may be applied to cause the electrically conductive fluid 10 to “crawl” toward one steering electrode, thus moving the interface surface to the proper position. An example of the electrowetting embodiment of the invention is illustrated in FIGS. 12A-12C.

Furthermore, although operation of the microfluidic device 1 of FIGS. 2A-2C has been described above through the application of electrokinetic forces, it will be readily apparent that the same configuration could be used to displace the interface surface according to magnetic force. Particularly, it will be readily apparent to those of ordinary skill in the art to utilize fluids 10 and 20 with different magnetic properties, in such a manner that operation of drive unit 40 causes one of the fluids to be magnetically attracted/repulsed to a corresponding steering magnetic field (e.g., by coils, magnet, etc.) to appropriately move the interface surface.

While FIGS. 2A-2C are directed to an embodiment utilizing electrophoresis, other embodiments are also covered by the present invention. For instance, according to various alternative embodiments, the drive unit 40 may apply electrical or magnetic forces directly on the floater object 50 to cause the flattened interface surface to change positions. For purposes of illustration, three particular examples of this are described below in connection with an electrically charged floater object 50A, a conductive floater object 50B, and a strongly dielectric floater object 50C.

FIGS. 4A-4C and 5A-5C illustrate embodiments in which the drive unit 40 applies electrical forces directly to an electrically charged floater object 50. In such an embodiment, neither of the fluids 10 and 20 need to carry any electrical charge. Thus, fluids 10 and 20 may help hold the floater object 50 in a particular position corresponding to the voltage(s) applied to the steering electrodes 410 and 420. In other words, movement of the floater object 50, based on the electrical forces applied by the steering electrodes 410 and 420, cause the fluids 10 and 20 to shift accordingly.

In FIGS. 4A-4C, the selective application of voltage to the steering electrodes 410 and 420 causes the charged floater object 50A to move, based on attractive forces, similar to the charged fluid 10 of FIGS. 2A-2C. Particularly, these figures show how the selective application of a positive voltage to a particular steering electrode 410, 420 may be used to attract negatively charged floater object 50A, thereby shifting the flattened interface surface to a particular operative position.

Further, FIGS. 5A-5C show how the selective application of a negative voltage to the steering electrodes 410 and 420 may be used to move the charged floater object 50 into an operative position, based on repulsive forces (similar to the charged fluid 10 of FIGS. 3A-3C).

In implementing the embodiments of FIGS. 4A-4C or FIGS. 5A-5C, it will be readily apparent to those of ordinary skill in the art how to configure the microfluidic device 1, 1′ to apply a negative charge to floater object 50A. The floater object 50A may be made of electret material, such as Teflon™-based electret.

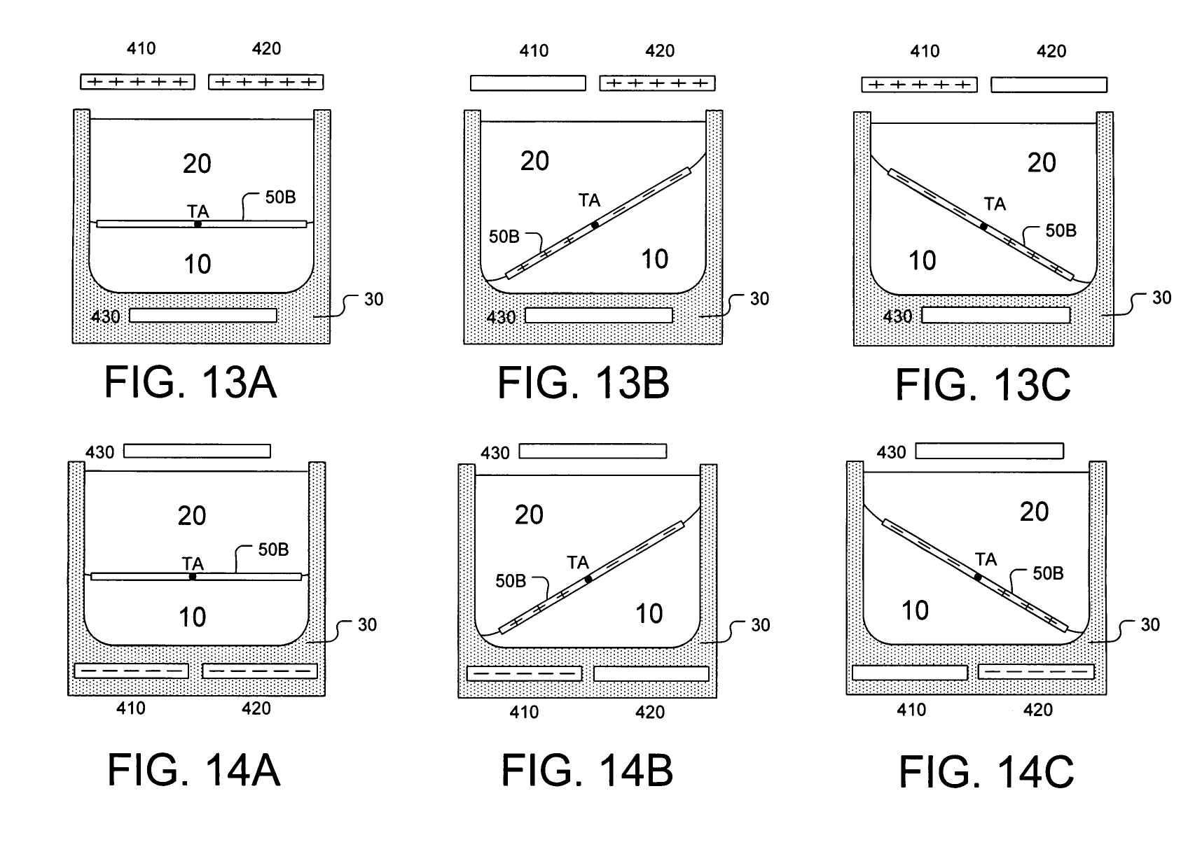

As another alternative, however, the floater object 50 may simply be made of an electrically conductive material. Examples of this are illustrated in FIGS. 13A-13C and FIGS. 14A-14C, in which floater object 50B is electrically conductive. As such, when a uniform charge (positive or negative) is applied to the steering electrodes 410 and 420, the floater object 50B is at an electrically neutral state (as shown in FIGS. 13A and 14A). However, the non-uniform application of voltage to the steering electrodes 410 and 420 cause one of the steering electrodes to attract mobile charges in the conductive floater object 50B, thereby causing the flattened interface object to move into an operative position (as shown in FIGS. 13B, 13C, 14B, and 14C).

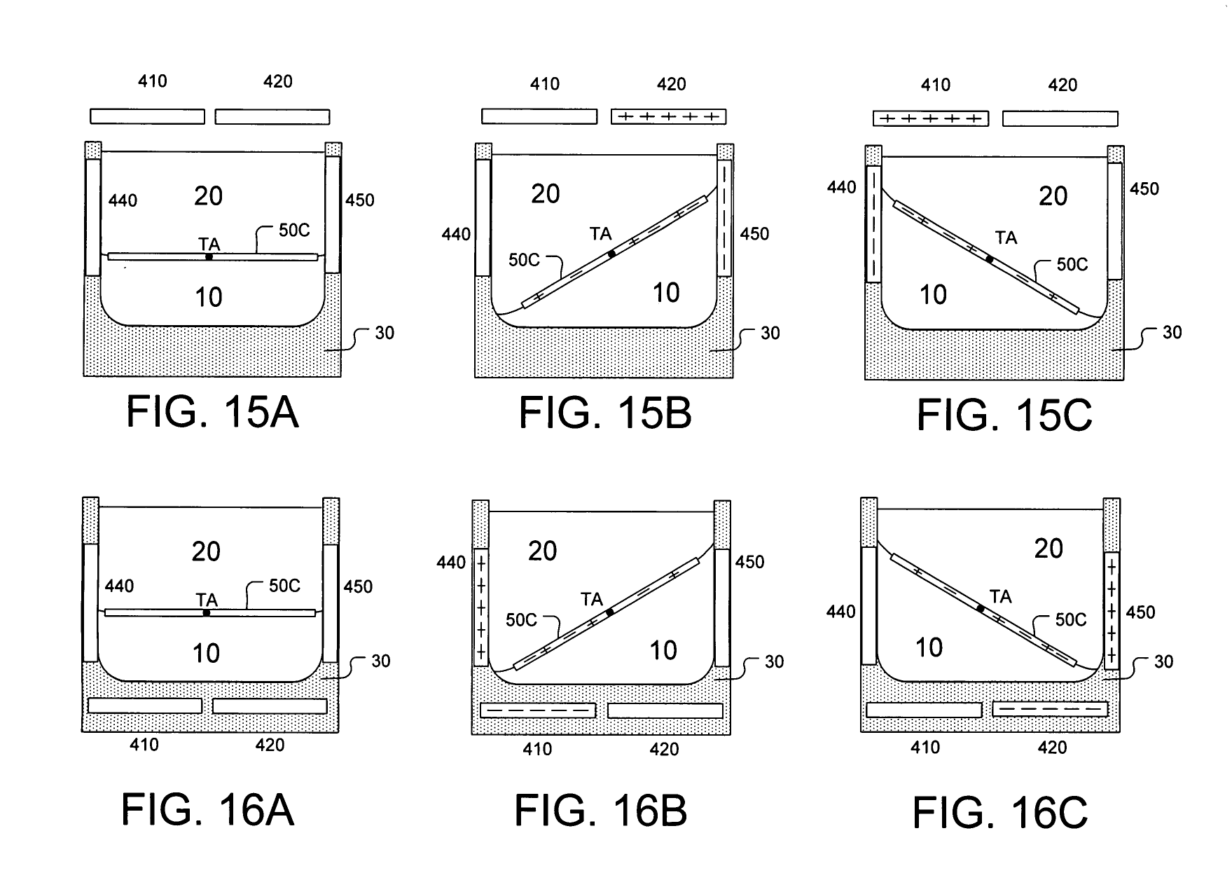

Further, another alternative would be to use a floater object 50, which is made of a strongly dielectric material. Examples of this are illustrated in FIGS. 15A-15C and FIGS. 16A-16C, in which floater object 50C is dielectric. According to these embodiments, in addition to the steering electrodes 410 and 420 above or below the reservoir 30, the electric drive unit 40 may include an additional set of steering electrodes 440 and 450 in the side walls of the reservoir 30. As such, when a non-uniform electric field is applied via the steering electrodes 410, 420, 440, and 450, the dielectric floater object is attracted toward the area where the electric field is the strongest (as shown in FIGS. 15B, 15C, 16B, and 16C).

In view of the various embodiments described above, those of ordinary skill in the art will realize that various types of electrical or magnetic forces may be used by the drive unit 40 to selectively displace the flattened interface surface into different operative positions. Thus, the present invention covers any obvious variations of the above described embodiments.

According to a further aspect of the invention, the floater object 50 is designed to remain in a state of floatation at the interface between the fluids 10 and 20. As such, the size and density of the floater object 50 are designed in such a manner as to ensure that the object 50 remains in a floatative state at this interface between the fluids 10 and 20, regardless of the tilt imposed on this interface by the drive unit 40. Furthermore, the properties of the reservoir 30 must be designed to ensure that the floater object 50 does not make contact with the reservoir walls. It will be readily apparent to those of ordinary skill in the art how to design the density and size of the floater object 50, as well as the properties and dimensions of the reservoir 30 based on these parameters.

As shown in the description above, the position of the interface surface (and, thus, floater object 50) may be selectively switched in accordance with an electronic drive unit 40. Furthermore, it will be shown that the flattened interface surface can be used to selectively redirect incoming light at different angles in relation to the tilt position controlled by the electronic drive unit 40. As such, each microfluidic device 1, 1′ may be configured as a pixel element in a projection display system.

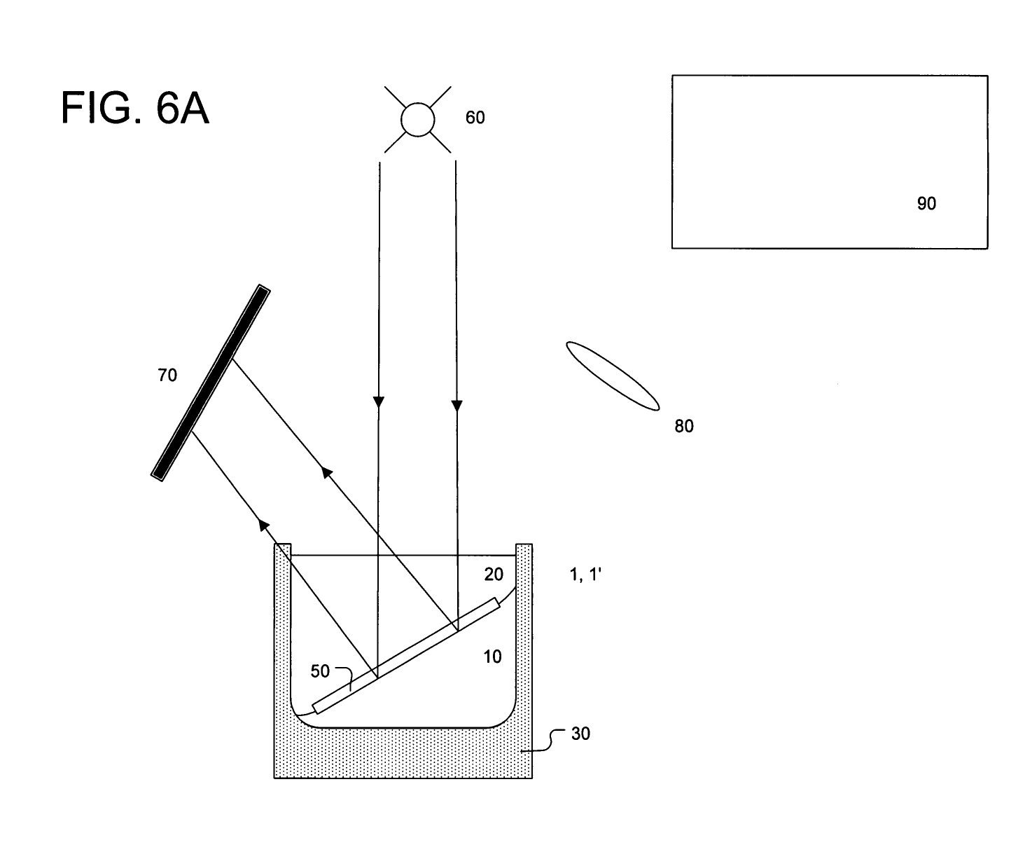

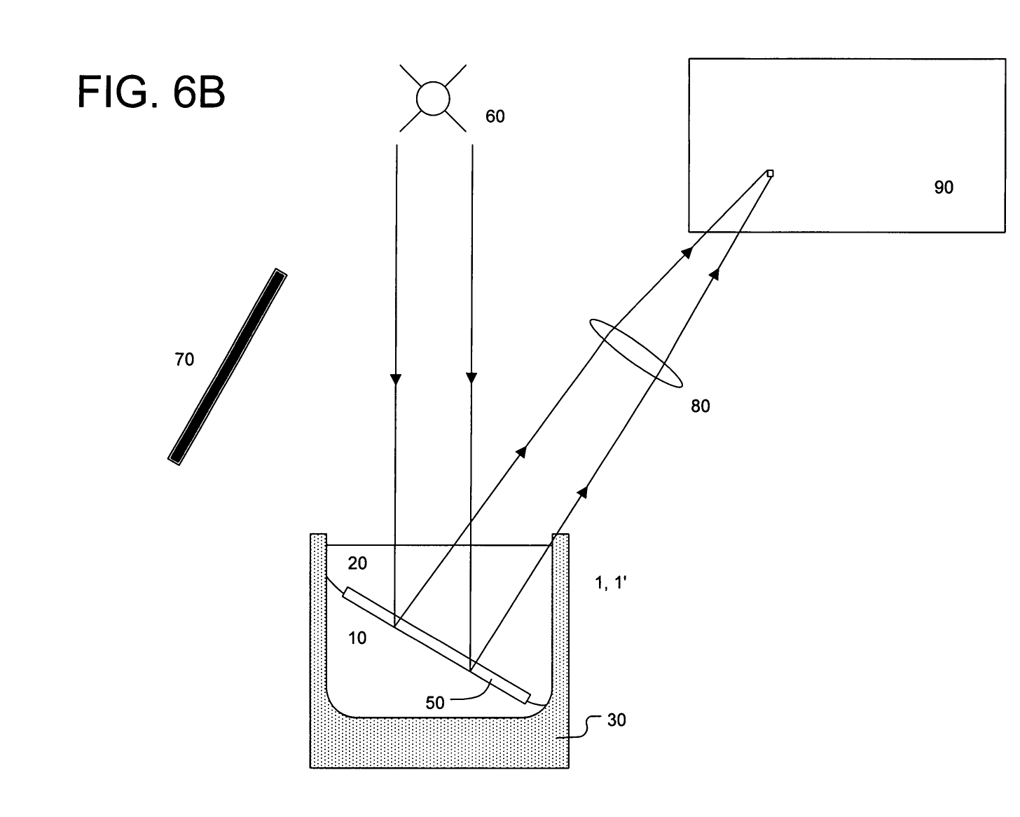

FIGS. 6A and 6B conceptually illustrate the use of a microfluidic device 1, 1′ as a reflective-type pixel element in a projection image display system, according to an exemplary embodiment. These figures illustrate a light source 60 emitting toward the interface surface and floater object 50 of the microfluidic device 1, 1′. These figures also illustrate an absorptive surface 70 (e.g., black surface) suitable for absorbing light. Furthermore, the system illustrated in FIGS. 6A and 6B include an optical system 80 and the display surface 90 (e.g., projection screen).

For the embodiment of FIGS. 6A and 6B, either the floater object 50 or the fluid 10 may be configured with the requisite reflective properties for redirecting the incoming light to the appropriate location based on the ON/OFF state. Using a reflective floater object 50 might be advantageous in the sense that it is unnecessary to install a reflective fluid 10 in the device 1, 1′. This may provide much more flexibility in choosing the type of fluid 10 to be used.

FIG. 6A illustrates a particular situation where the microfluidic device 1, 1′ is set in the OFF state. Accordingly, the flattened interface surface is set to the OFF position, thereby reflecting the incoming light from light source 60 toward the absorptive surface 70. On the other hand, FIG. 4B illustrates the situation where the microfluidic device 1, 1′ is in the ON state. Accordingly, the flattened interface surface is set in the ON position, thereby reflecting light toward the display surface 90 via the optical system 80. For example, the optical system 80 may include a projection lens configured to focus light toward the particular pixel corresponding to the microfluidic device 1, 1′. However, the optical system 80 may include any arrangement of optical elements suitable for focusing light from the flattened interface surface (in ON position) towards the corresponding pixel, as will be contemplated by those of ordinary skill in the art.

As illustrated in FIGS. 6A and 6B, the projection display system may include a microfluidic device 1 corresponding to the embodiment illustrated in FIG. 1A. Accordingly, the drive unit 40 may be disposed above the microfluidic device 1. To facilitate this, in an exemplary embodiment, the steering electrodes 410 and 420 of the drive unit 40 are made optically transparent in order to allow the incoming light to pass through. Also, the reservoir 30 may be constructed of an optically transparent material to help ensure that the incoming light is reflected unobstructedly towards the absorptive surface 70 and display surface 90 as appropriate.

If the system illustrated in FIGS. 6A and 6B utilize a microfluidic device 1′ corresponding to the embodiment of FIG. 1B, the reservoir 30 may similarly be constructed of an optically transparent material to facilitate the unobstructed reflection of light.

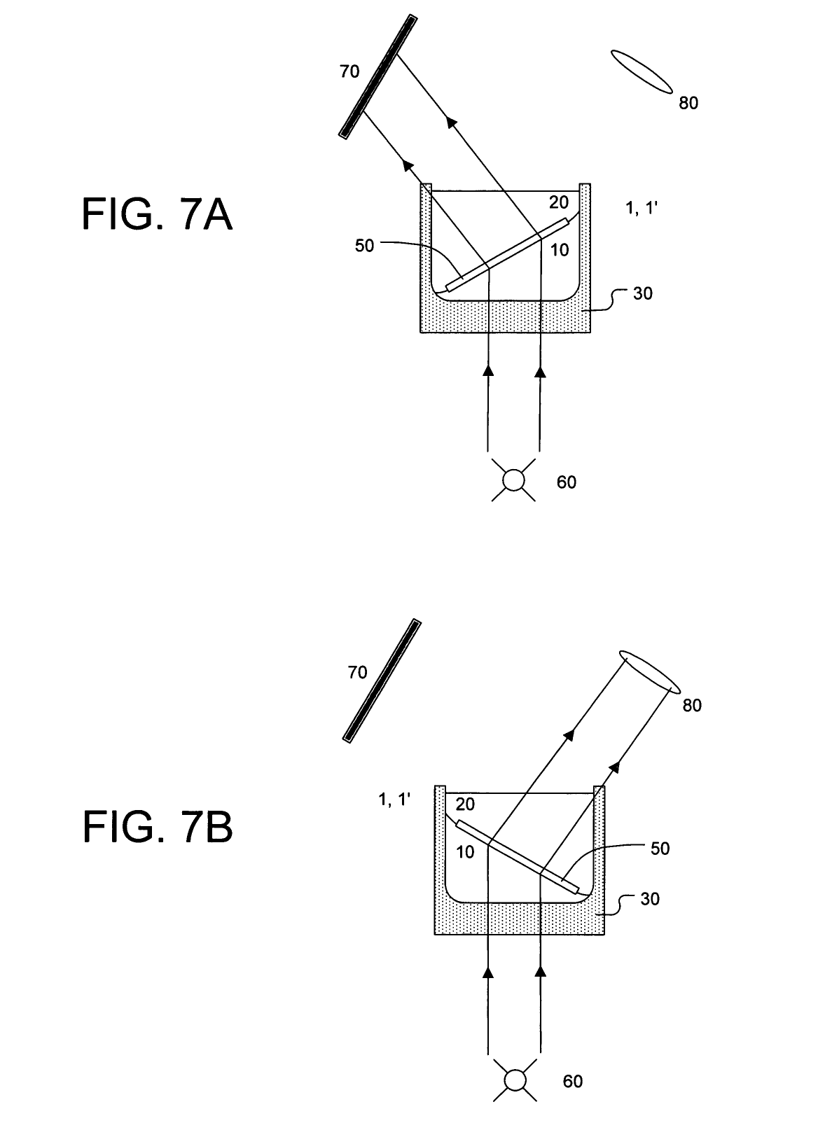

FIGS. 7A and 7B conceptually illustrate an image projection system according to an alternative exemplary embodiment in which the input light is transmitted through the reservoir 30 and refracted by the flattened interface surface of the microfluidic device 1, 1′ toward the absorptive surface 70 or display surface 90 (not shown) via the optical system 80. Of course, as illustrated in this embodiment, the reservoir 30 is optically transparent in order to allow the light from source 60 to transmit through to the flattened interface surface. Furthermore, the steering electrodes 410 and 420 (not shown) may also be optically transparent to facilitate the unobstructed transmission of light.

In FIGS. 6A and 6B and FIGS. 7A and 7B, it should be noted that the floater object 50 helps eliminate curvature between fluids 10 and 20. The lack of curvature, in turn, helps ensure that the incoming light is precisely directed to the proper location by preventing unwanted dispersion of the reflected/refracted rays.

To ensure that the flattened interface surface directs the incoming light to the proper location based on its ON/OFF state, the fluids 10 and 20 may be designed with different optical characteristics. For example, in the case shown in FIGS. 6A and 6B, fluid 10 may be reflective while fluid 20 is optically clear. In the alternative case of FIGS. 7A and 7B, the fluids 10 and 20 may have different refraction coefficients to ensure proper refraction of the light. It will be readily apparent to those of ordinary skill in the art what optical characteristics are required of the fluids 10 and 20 to ensure proper operation of the microfluidic device 1, 1′.

However, as described above, it might be possible to incorporate the necessary reflective/refractive properties into the floater object 50, instead of relying on fluids 10 and 20 with different optical characteristics. For example, in connection with the embodiment of FIGS. 6A and 6B, it is possible to use a reflective floater object 50 along with two optically clear fluids 10 and 20. Similarly, in the embodiment of FIGS. 7A and 7B, a floater object 50 with prismatic qualities may be implemented between optically clear fluids 10 and 20 to refract the incoming light to the appropriate location.

FIGS. 2A-2C show a particular example where two steering electrodes 410 and 420 selectively displaces the flattened interface surface of microfluidic device 1 into one of three operative positions, or tilt angles, with respect to a particular tilt axis TA (however, the number of possible tilt angles in this embodiment is not limited to three). Further, according to an alternative exemplary embodiment, the drive unit 40 may include more than two steering electrodes in order to add to the operative positions into which the flattened interface surface can be selectively displaced.

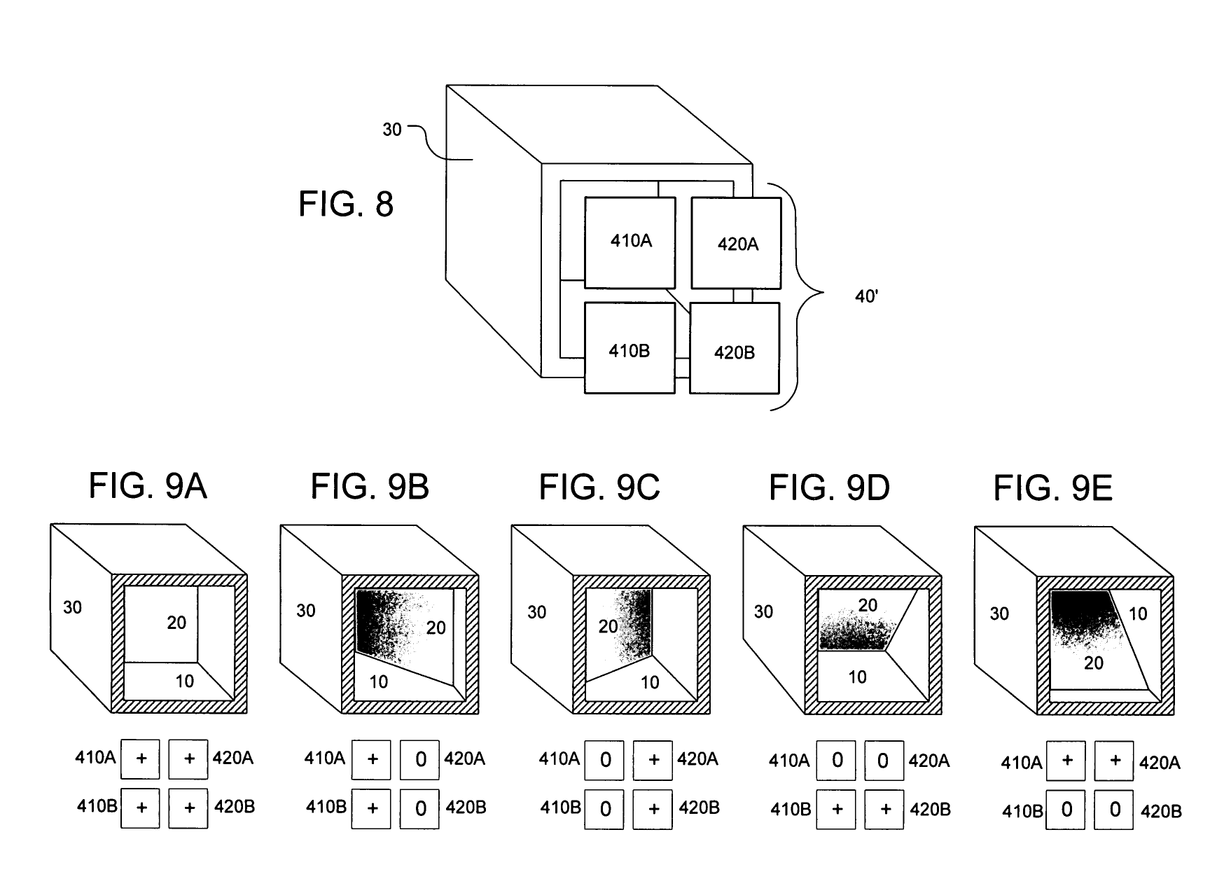

According to an exemplary embodiment, four steering electrodes may be implemented in the drive unit of a microfluidic device. FIG. 8 illustrates a drive unit 40′ containing four steering electrodes 410A, 410B, 420A, and 420B. For purposes of illustration, the drive unit 40′ of FIG. 8 is illustrated as being implemented above the reservoir 30 of the microfluidic device, similar to the configuration of the microfluidic device 1 illustrated in FIG. 1A. However, it will be readily apparent to those of ordinary skill in the art that the drive unit 40′ could also be implemented below the first and second fluids 10 and 20 in reservoir 30, i.e., in a configuration similar to the embodiment illustrated in FIG. 1B.

In particular, the use of four steering electrodes 410A, 410B, 420A, and 420B allows for two-dimensional tilting of the flattened interface surface. Such two-dimensional tilting is illustrated in FIGS. 9A-9E. For simplicity, the floater object 50 is not illustrated in these figures. However, to illustrate the effects of the floater object 50, the interface between fluids 10 and 20 is shown in a flattened state.

The operative principles of two-dimensional tilting will be described below in relation to FIGS. 9A-9E. For purpose of illustration, these figures and the accompanying description assume a configuration with the steering electrodes 410A, 410B, 420A, and 420B above the reservoir 30, as shown in FIG. 8. However, it will be readily apparent to those of ordinary skill in the art how the operative principles would apply to an embodiment with the drive unit 40′ implemented below the fluids 10 and 20.

It should be noted that FIGS. 9A-9E each illustrates a view facing (and looking through) the bottom wall of the reservoir 30. Below each figure is a diagram illustrating the voltages selectively applied to the steering electrodes 410A, 410B, 420A, and 420B. However, the position of the actual steering electrodes 410A, 410B, 420A, and 420B with respect to the microfluidic device (i.e., above reservoir 30) in this embodiment is not actually shown.

As similarly described above in connection with FIGS. 2A-2C, the selective application of positive voltage to steering electrodes 410A, 410B, 420A, and 420B in FIGS. 9A-9E causes the flattened interface surface to take on a particular tilt. However, according to an exemplary embodiment in relation to FIGS. 9A-9E, the positive voltage may be selectively applied to multiple electrodes to displace the interface surface to a different position.

As shown in FIG. 9A, the application of positive voltage to all of the steering electrodes 410A, 410B, 420A, and 420B causes a uniform electric field above fluids 10 and 20, thereby causing little or no tilt. However, as illustrated in FIGS. 9B-9E, the application of voltage to any adjacent pair of steering electrodes causes the electrically conductive electrodes to be attracted to those electrodes.

For example, in FIG. 9B, selectively applying a positive voltage to steering electrodes 410A and 410B causes the electrically conductive fluid 10 to be attracted to those electrodes, thus causing the flattened interface surface to tilt toward electrodes 410A and 410B. Similarly, in FIG. 9C, the selective application of positive voltage to electrodes 420A and 420B causes the electrically conductive fluid 10 to be attracted to those electrodes, thus causing the flattened interface surface to tilt toward electrodes 420A and 420B. The same effect is shown in FIG. 9D, in which the positive voltage is selectively applied to electrodes 410B and 420B; and in FIG. 9E, in which the positive voltage is selectively applied to electrodes 410A and 420A.

Although four steering electrodes are shown in the embodiment of FIG. 8 and FIGS. 9A-9E, it should be noted that the number of steering electrodes could be increased further in order to provide tighter control of the position of the flattened interface surface. For example, increasing the number of steering electrodes may increase precision and allow for additional operative positions for the flattened interface surface.

As described above, exemplary embodiments of the present invention contemplate a projection image display system in which a microfluidic device 1, 1′ redirects light (by reflection or refraction) to an external absorptive surface 70 while in the OFF state. However, in an alternative exemplary embodiment, a microfluidic device may be configured such that an internal absorptive surface is implemented in the walls of the reservoir 30. According to this embodiment, the microfluidic device may be configured to utilize total internal reflection to redirect the incoming light to the absorptive surface while in the OFF state.

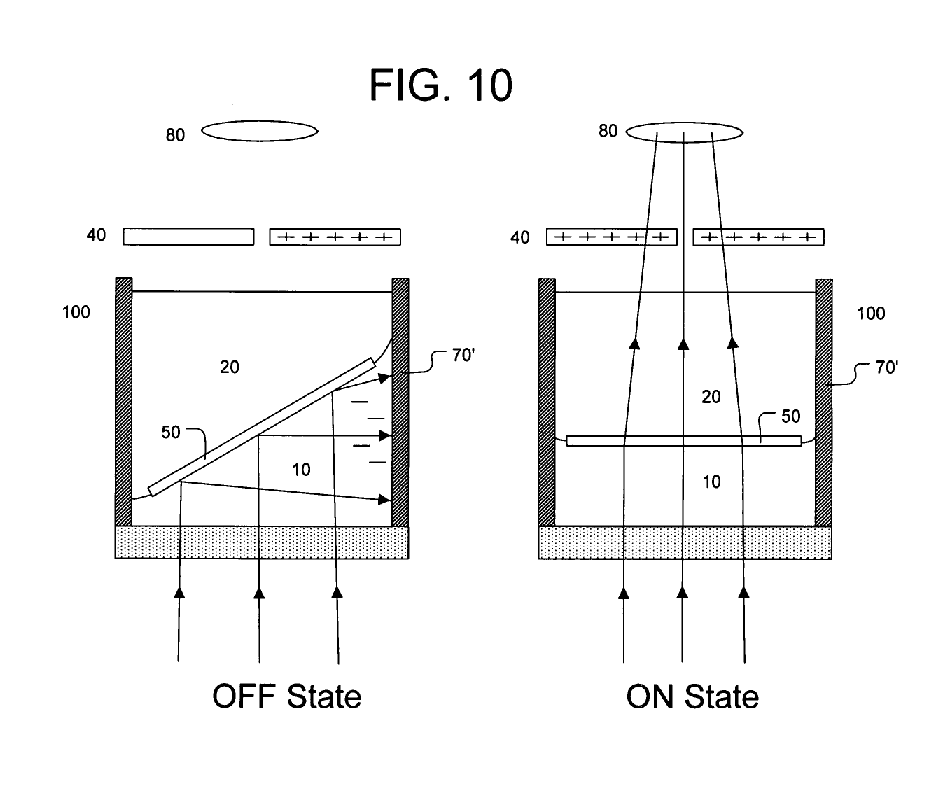

FIG. 10 illustrates a microfluidic device 100 utilizing total internal reflection, according to an exemplary embodiment. As shown in FIG. 10, while in the OFF state, the drive unit 40 may be configured to drive the interface surface to a particular tilt angle, thereby causing the incoming light to be redirected toward the absorptive surface 70′ incorporated in the inner wall of the reservoir 30. Since fluid 10 is displaced toward the wall incorporating the absorptive surface 70′, the fluid 10 may be operable to cool the absorptive surface 70′ as it absorbs the incoming light.

According to FIG. 10, while the microfluidic device 100 is in the ON state, it may not be necessary for the drive unit 40 to cause the interface surface and floater object 50 to tilt. E.g., as shown in FIG. 10, the optical system 80 and display surface 90 (not shown) may be configured to receive light transmitting through the microfluidic device 100 while the flattened interface surface is at a non-tilting position.

An imaging system incorporating a microfluidic device 100 that uses total internal reflection may have the advantage of a more compact design. This may be accomplished since there is no need for an external absorptive surface, and a more straightforward path from each microfluidic device 100 to the display surface 90.

In an exemplary embodiment, multiple microfluidic devices configured according to the principles of the present invention may be arranged as an imaging array to be implemented in a projection-type imaging system. In such an embodiment, each microfluidic device may be configured as a pixel element in the imaging system. Furthermore, the operation of the electrical drive unit 40 for each microfluidic device is compatible with thin-film transistor (TFT) processes that are used in the manufacture of, e.g., liquid crystal display (LCD) panels.

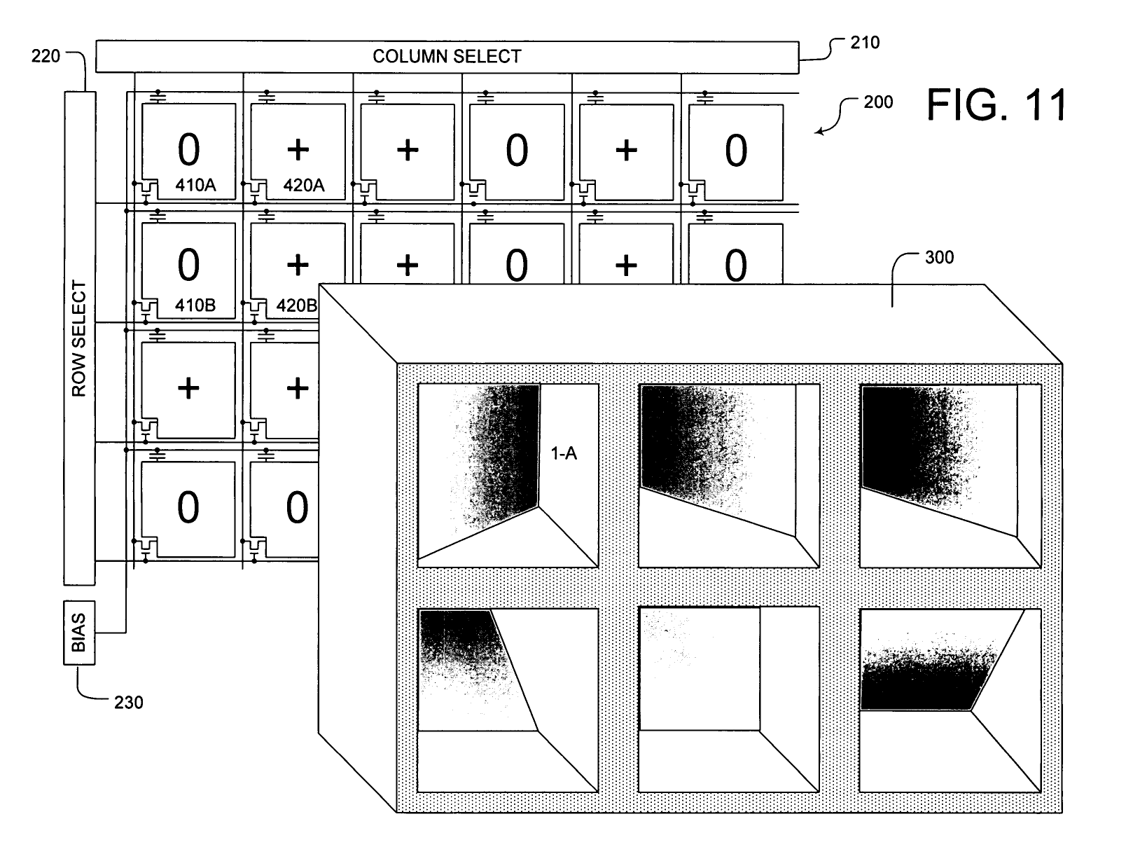

Thus, according to an exemplary embodiment, the electrical drive units 40 for an imaging array of microfluidic devices may be implemented using a TFT circuit. FIG. 11 illustrates a TFT circuit 200 configured to drive an imaging array 300 of microfluidic devices, according to an exemplary embodiment.

For purposes of illustration, the microfluidic devices in array 300 of FIG. 11 are consistent with the embodiment described above in connection with FIG. 6, i.e., using two-dimensional tilting of the interface surface. However, it should be noted that in alternative embodiments, a TFT circuit may be configured to drive an array of microfluidic devices 1 or 1′, which are described above in connection with FIGS. 1A and 1B, respectively.

Referring to FIG. 11, the shaded steering electrodes 410A, 410B, 420A, and 420B are part of the drive unit 40 for the particular microfluidic device 1-A in imaging array 300. Similarly, each of the other microfluidic devices in the array 300 have a corresponding set of steering electrodes 410A, 410B, 420A, and 420B in the TFT circuit 200.

In FIG. 11, the COLUMN SELECT and ROW SELECT units 210 and 220, respectively, of the TFT circuit 200 may be configured to respond to control signals from a display controller (not shown). Based on such control signals, for each microfluidic device, the COLUMN SELECT and ROW SELECT units 210 and 220 are configured to control a transistor coupled to each steering electrode 410A, 410B, 420A, and 420B to charge the corresponding capacitance to a certain voltage level, where it remains until the next refresh cycle. As such, each transistors can be assigned an x-y address in the TFT circuit, so that the COLUMN SELECT and ROW SELECT units 210 and 220 to drive each steering electrode separately.

Exemplary embodiments having been described above, it should be noted that such descriptions are provided for illustration only and, thus, are not meant to limit the present invention as defined by the claims below. Any variations or modifications of these embodiments, which do not depart from the spirit and scope of the present invention, are intended to be included within the scope of the claimed invention.

What is claimed is:

1. A microfluidic device comprising:
a reservoir containing immiscible fluids, wherein an interface surface formed between the immiscible fluids is selectively switched between different operative positions; and
an interface object configured to inhibit curvature of the interface surface.

2. The device of claim 1, wherein the interface object is optically transparent.

3. The device of claim 1, wherein
the first and second fluids have different refraction indices, and
the interface object has an index of refraction substantially equal to that of the first or second fluid.

4. The device of claim 1, wherein the interface object is reflective.

5. The device of claim 1, wherein
the reservoir contains first and second fluids, the first and second fluids having different electrical or magnetic properties, the first and second fluids being immiscible, and
the interface object is disposed in a state of flotation between the first and second fluids, thereby forming a substantially flat interface surface between the first and second fluids.

6. The device of claim 5, further comprising:
a drive unit for selectively displacing the interface surface into at least two different positions via an electrical or magnetic force,
wherein the interface object is configured to remain in a state of flotation between the first and second fluids as the interface surface is selectively displaced between the different positions, respectively.

7. The device of claim 6, wherein
the interface object is electrically charged, and
the drive unit includes at least two steering electrodes, the drive unit being configured to selectively displace the interface object by selectively generating electric forces between the steering electrodes and the charged interface object.

8. The device of claim 6, wherein
the interface surface is configured to receive light transmitted by a source, and
the interface surface is further configured to reflect or refract the received light to one of at least two predetermined locations, each predetermined location corresponding to a respective one of the at least two different positions into which the interface surface is selectively displaced.

9. The device of claim 8, wherein the optical qualities of the interface object is designed to reflect or refract the light to the appropriate one of the two predetermined positions based on the position of the interface surface.

10. The device of claim 6, wherein the interface object is configured such that a clearance is maintained between the edges of the interface object and the inner walls of the reservoir as the interface surface is selectively displaced between the different positions.

11. The device of claim 1, wherein the interface object is disc-shaped.

12. A microfluidic device comprising:
a reservoir containing immiscible fluids, wherein an interface surface formed between the immiscible fluids is selectively switched between different operative positions; and
an interface object configured to inhibit curvature of the interface surface,
wherein the interface surface is configured to redirect incoming light to a location dependent upon the current operative position.

13. The device of claim 12, wherein
the reservoir contains first and second fluids, the first and second fluids having different electrical or magnetic properties, the first and second fluids being immiscible, and
the interface object is disposed in a state of flotation between the first and second fluids, thereby forming a substantially flat interface surface between the first and second fluids.

14. The device of claim 13, further comprising:
a drive unit for selectively displacing the interface surface into at least two different positions via an electrical or magnetic force,
wherein the interface object is configured to remain in a state of flotation between the first and second fluids as the interface surface is selectively displaced between the different positions, respectively.

15. The device of claim 12, wherein the interface object is configured such that a clearance is maintained between the edges of the interface object and the inner walls of the reservoir as the interface surface is selectively displaced between the different positions.

16. The device of claim 12, wherein the interface surface is configured to redirect the light by reflection.

17. The device of claim 12, wherein the interface surface is configured to redirect the light by refraction.

18. A device including an array of microfluidic devices as recited in claim 12.

19. A microfluidic device comprising:
a reservoir;
first and second fluids contained within the reservoir, the first and second fluids having different electrical or magnetic properties, wherein the first and second fluids are immiscible;
an interface object disposed in a state of flotation between the first and second fluids, thereby providing a substantially flat interface surface between the first and second fluids;
a drive unit for selectively displacing the substantially flat surface into at least two different positions via an electrical or magnetic force,
wherein the interface object is configured to remain in a state of flotation between the first and second fluids as the substantially flat surface is selectively displaced between the different positions, respectively.

20. The device of claim 19, wherein
the interface surface is configured to receive light transmitted by a source, and
the interface surface is further configured to reflect or refract the received light to one of at least two predetermined locations, each predetermined location corresponding to a respective one of the at least two different positions into which the interface surface is selectively displaced.
